(19) United States
(12) Patent Application Publication
(10) Pub. No.: US 2006/0068421 A1
(43) Pub. Date: Mar. 30, 2006

(54) Compositions and methods for phage display of polypeptides

(75) Inventors: Jeff Gray, Solana Beach, CA (US); Gunars Valkirs, Escondido, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Biosite, Inc., San Diego, CA (US)

(21) Appl. No.: 11/198,920

(22) Filed: Aug. 5, 2005

Related U.S. Application Data
(60) Provisional application No. 60/599,594, filed on Aug. 5, 2004.

(51) Int. Cl. C40B 40/02

(52) U.S. Cl. 435/6; 435/472

(57) ABSTRACT

The present invention relates in part to novel polypeptide display methods that can permit the efficient display and selection of polypeptides, and to display vectors and other compositions configured for efficient use in such methods.

### CROSS-REFERENCE TO RELATED APPLICATION

The present application is a nonprovisional and claims the benefit of U.S. Ser. No. 60/599,594, filed Aug. 5, 2004, which is incorporated by reference in its entirety for all purposes.

### FIELD OF THE INVENTION

The present invention relates to novel phage display vectors, and to methods for their production and use.

### BACKGROUND OF THE INVENTION

The following discussion of the background of the invention is merely provided to aid the reader in understanding the invention and is not admitted to describe or constitute prior art to the present invention.

The term “phage display” refers to a set of techniques for the display and selection of polypeptides on the surface of particles produced from a replicable genetic package (e.g., a bacteriophage). As first described by Smith in 1985 for the display of EcoRI endonuclease (Science 228: 1315-17), phage display methods comprise expressing a polypeptide of interest as a fusion protein attached to a bacteriophage coat protein. Progeny bacteriophage are extruded from host bacteria (e.g., E. coli), and “panning” techniques that involve binding of the polypeptide of interest to a cognate binding partner are used to enrich those bacteriophage displaying the polypeptide of interest relative to other bacteriophage in the population. Smith initially reported that selection methods could be used to enrich phage displaying an EcoRI endonuclease-pIII fusion over 1000-fold. This display-and-select methodology has been extended and advanced, so that today large libraries (>10⁷ to as many as >10¹⁰) individual polypeptide variants may be rapidly and conveniently screened for a particular binding property of interest. See, e.g., WO 91/19818; WO 91/18989; WO 92/01047; WO 92/06204; WO 92/18619; Han et al., Proc. Natl. Acad. Sci. USA 92: 9747-51, 1995; Donovan et al., J. Mol. Biol. 196: 1-10, 1987.

Phage display often employs E. coli filamentous phage such as M13, fd, f1, and engineered variants thereof (e.g., fd-tet, which has a 2775-bp BglII fragment of transposon Tn10 inserted into the BamHI site of wild-type phage fd; because of its Tn10 insert, fd-tet confers tetracycline resistance on the host and can be propagated like a plasmid independently of phage function) as the displaying replicable genetic package. Non-filamentous phage (e.g., lambda), spores, eukaryotic viruses (e.g., Moloney murine leukemia virus, baculovirus), and phagemids offer important alternative genetic packages for use in phage display. Likewise, bacteria such as E. coli, S. typhimurium, B. subtilis, P. aeruginosa, V. cholerae, K. pneumonia, N. gonorrhoeae, N. meningitides, etc., offer alternatives to the use of bacteriophage for display of polypeptides.

Considering M13 as an exemplary filamentous phage, the phage virion consists of a stretched-out loop of single-stranded DNA (ssDNA) sheathed in a tube composed of several thousand copies of the major coat protein pVIII (product of gene VIII). Four minor coat proteins are found at the tips of the virion, each present in about 4-5 copies/virion: pIII (product of gene III), pIV (product of gene IV), pVII (product of gene VII), and pIX (product of gene IX). Of these, pIII and pVIII (either full length or partial length) represent the most typical fusion protein partners for polypeptides of interest. A wide range of polypeptides, including random combinatorial amino acid libraries, randomly fragmented chromosomal DNA, cDNA pools, antibody binding domains, receptor ligands, etc., may be expressed as fusion proteins e.g., with pIII or pVIII, for selection in phage display methods. In addition, methods for the display of multichain proteins (where one of the chains is expressed as a fusion protein) are also well known in the art.

Fusions of a polypeptide of interest to a phage coat protein, however, is obviously a highly artificial system from the point of view of the phage, and can create problems for the artisan seeking to employ phage display methodology. For example, pIII is required for attachment of the phage to its host cell; as the polypeptide of interest increases in size, its presence on pIII hinders this attachment, resulting in a loss of infectivity. As a result, contaminating phage lacking the fusion protein can outcompete the phage displaying the polypeptide of interest for infection of the host cells, reducing or even preventing successful enrichment for the polypeptide. In the case of pVIII, fusions can compromise coat protein function generally.

To overcome such difficulties at least in part, various strategies have been developed. For example, the phage genome may be introduced by electroporation rather than by reliance on natural phage infection. Such methods may provide reduced efficiencies of replication however. Alternatively, hybrid systems that contain a mixture of wild type and fusion coat protein in the same virion (e.g., “33,” “3+3,” “88,” and “8+8” vectors) may be employed, either with (e.g., 3+3) or without (e.g., 33) the use of helper phage. Such methods may be tuned to provide “monovalent” phage display; that is, the phage particles display mostly zero or one copy of the fusion protein. While monovalent display may help to increase the selection of high affinity binding interactions, multivalent display may lead to more efficient selection. See, e.g., WO 01/40306.

Ward et al., J. Immunol. Meth. 189: 73-82, 1996, reported the introduction of a proteolytic cleavage site into a phage display vector encoding a pIII/sFv fusion protein for use in enzymatically eluting bacteriophage bound to a solid substrate during the selection (panning) phase. Cleavage at the protease site introduced between the pIII and sFv sequences was reported to not alter infectivity of the bacteriophage as compared to treatment of the same bacteriophage with either 100 mM glycine, pH 3.0 or a pH 8.0 buffer.

Kristensen and Winter, Folding and Design 3: 321-28, 1998, reported the introduction of a proteolytic cleavage site into a phage display vector encoding a pIII/enzyme fusion protein for use in identifying proteolytically stable enzyme sequences.

Each reference cited in the preceding and followings sections is hereby incorporated by reference in its entirety, including all tables, figures, and claims.

There remains a need in the art for methods and compositions permitting efficient display and selection of polypeptides that interfere with the normal function of the genetic package being employed.

### BRIEF SUMMARY OF THE INVENTION

The present invention relates in part to novel polypeptide display methods that permit the display and selection of polypeptides that may interfere with genetic package function, and to display vectors configured for efficient use in such methods. The present invention also relates in part to novel compositions and methods for efficient display of polypeptides as fusions with phage coat polypeptides.

In a first object of the invention, methods are provided for the propagation of replicable genetic packages displaying a polypeptide of interest. These methods comprise contacting the replicable genetic packages with one or more proteolytic enzymes that remove all or a portion of the polypeptide of interest from the surface of at least some of the replicable genetic packages. By this proteolysis, proteins on the surface of the replicable genetic packages that are being used for fusion protein display are “uncovered,” permitting these surface proteins to carry out their normal function. Following the proteolysis step, the replicable genetic packages are propagated by replication in host cells.

Taking fusion protein display on filamentous phage pIII as an example, the pIII protein can be divided into three distinct domains (denominated N1, N2, and C from N-terminal to C-terminal) separated from one another by glycine-rich linker peptides (denominated L1 between N1 and N2, and L2 between N2 and C). The domain structure of an exemplary pIII protein from M13 is depicted herein in FIG. 3. While full length pIII is involved in normal infection of bacterial by the bacteriophage, truncated forms (e.g., containing N1, L1, and C) display nearly wild-type levels of infectivity. See, e.g., Nilsson et al., J. Virol. 74: 4229-35, 2000. The methods of the present invention can permit display of the polypeptide of interest as a fusion with intact or truncated pIII for use in the selection phase of phage display.

Following selection, the selected phage (enriched for a binding interaction of interest) may be proteolyzed to remove at least a portion of the polypeptide of interest from the fusion protein, while retaining sufficient pIII sequences to permit infectivity of the bacteriophage for a host cell in order to provide replication and propagation of the displaying bacteriophage. The propagation phase of phage display can then take place using these proteolyzed bacteriophage, which can exhibit improved replication efficiency of the target bacteriophage relative to their unproteolyzed equivalents. In various embodiments, replication efficiency of the target bacteriophage is improved at least 2-fold, more preferably at least 3-fold, still more preferably at least 5-fold, even more preferably at least 10-fold, yet more preferably at least 20-fold, and most preferably at least 50-fold relative to their unproteolyzed equivalents.

While described hereinafter in detail with regard to such pIII fusions, the skilled artisan will understand that the methods described herein may find application to polypeptide display using replicable genetic packages generally.

In a first aspect, the present invention relates to methods for propagation of replicable genetic packages (rgps). These methods comprise contacting a population of rgps, one or more members of which display a polypeptide of interest on the surface thereof as a fusion protein with a full length or truncated package surface protein, with one or more proteolytic enzymes under conditions selected to remove all or a portion of the fusion protein(s) from the surface of one or more of said members, thereby preferably improving replication of population members displaying the polypeptide of interest; and contacting a host cell population with the resulting proteolyzed population of rgps under conditions selected to replicate one or more members of the population.

In various embodiments, the rgps that find use in these methods may be any that are commonly used in the art for polypeptide display methods, including bacteriophage (e.g., lambda, T-even phage such as T4, T-odd phage such as T7, etc.), spores, bacteria, yeast, eukaryotic viruses, etc.

In preferred embodiments, the rgps are bacteriophage, more preferably filamentous phage, and most preferably M13, fd, f1, or engineered variants thereof. Thus, in particularly preferred embodiments, the present invention relates to methods for performing phage display, which comprise expressing from host cells a bacteriophage population comprising one or more bacteriophage displaying a polypeptide of interest on a surface thereof as a fusion protein with a bacteriophage coat protein; enriching the proportion of bacteriophage displaying the polypeptide of interest by contacting the bacteriophage population with an affinity target for the polypeptide of interest and removing uncomplexed bacteriophage; contacting the enriched bacteriophage population with one or more proteolytic enzymes under conditions selected to remove all or a portion of the fusion protein from the surface of one or more of said bacteriophage, thereby preferably improving replication of bacteriophage displaying said polypeptide of interest; and replicating the proteolyzed bacteriophage population in host cells.

In the case of bacteriophage, production of the displaying rgps for use in the proteolysis step described above may rely on the bacteriophage genome for packaging of the bacteriophage and display of the fusion protein of interest. Alternatively, phagemid/helper phage and other “two vector” phage packaging systems are also within the scope of the present invention. See, e.g., Baek et al., Nucleic. Acids Res. 30, No. 5 e18, 2002; Sblattero et al., Rev. Mol. Biotechnol. 74: 303-15, 2001; Marzari et al., FEBS Lett. 411: 27-31, 1997.

With regard to the choice of proteolytic enzyme(s) for use in the present methods, the only requirement is that the enzyme(s) remove at least a portion of the displayed polypeptide(s) of interest from at least a portion of the displaying rgps present. In preferred embodiments, this proteolysis provides improved propagation of the displaying rgps in comparison to that seen in the absence of proteolysis. Exemplary methods for assessing this improved propagation are described hereinafter. In various embodiments, the proteolytic enzyme(s) employed are selected to cleave at a site that removes a portion of the polypeptide of interest from the fusion protein; removes all of the polypeptide of interest from the fusion protein; or removes all of the polypeptide of interest and a portion of the rgps package surface protein from the fusion protein.

In preferred embodiments, a protease cleavage site is engineered into the fusion protein to provide a desired site for action of the proteolytic enzyme(s) employed. Such a protease cleavage site may be introduced into the rgps package surface protein sequence, or most preferably, distally to the residues encoding the package surface protein (that is, following the last package surface protein residue that participates in fusion to the polypeptide of interest). As an example of this distal positioning, a protease cleavage site may be placed between the final residue of the package surface protein and before the first residue of the displayed polypeptide of interest; alternatively, a protease cleavage site may be placed after the final residue of the package surface protein but within the displayed polypeptide of interest. As in the choice of proteolytic enzyme(s) for use in the present methods, all that is required is that cleavage at the introduced cleavage site remove at least a portion of the displayed polypeptide(s) of interest from at least a portion of the displaying rgps present, and in preferred embodiments, such cleavage improves propagation of the displaying rgps in comparison to that seen in the absence of proteolysis.

Numerous proteolytic enzymes (e.g., trypsin, subtilisin, thermolysin, chymotrypsin, papain, etc.) and corresponding protease cleavage sites are known to those of skill in the art. In preferred embodiments, one or more proteolytic enzymes for use in the present methods are selected from the group consisting of factor Xa, enterokinase, thrombin, tobacco etch virus protease, and human rhinovirus 3C protease. In yet other preferred embodiments, an introduced proteolytic cleavage site is selected from the group consisting of JEGR, DDDDK, LVPRGS, ENLYFQG, and LEVLFQGP.

In certain embodiments, the methods described herein further comprise an enrichment step, which increases the proportion of rgps displaying the polypeptide of interest in the rgps population. Such methods, which preferably employ binding to an affinity binding partner for the polypeptide of interest, are well known in the art. Exemplary enrichment methods are described hereinafter. When an enrichment step is performed, it is preferably completed prior to contacting the rgps population with the proteolytic enzyme(s) used to remove at least a portion of the displayed polypeptide(s) of interest.

Moreover, the methods described above may be repeated for 1 or more additional cycles of: display of polypeptide(s) of interest on rgps->enrichment of rgps for a particular binding interaction->cleavage of at least a portion of the displayed polypeptide(s) of interest with proteolytic enzyme(s)->propagation by replication of the proteolyzed rgps. By cycling this procedure through 2, 3, 4, 5, or more cycles, substantial enrichment (>1000-fold, more preferably >10,000-fold, and still more preferably >100,00⁰-fold) of rgps displaying a polypeptide of interest may be achieved.

The methods described herein may be used to display a variety of polypeptides, including but not limited to random combinatorial amino acid libraries, polypeptides encoded by randomly fragmented chromosomal DNA, polypeptides encoded by cDNA pools, polypeptides encoded by EST libraries, antibody binding domains, receptor ligands, and enzymes. Such polypeptides may be displayed as single chains or as multichain complexes.

Furthermore, additional steps well known in the phage display art, such as combinatorial chain shuffling, humanization of antibody sequences, introduction of mutations, affinity maturation, use of mutator host cells, etc., may be included in the methods described herein at the discretion of the artisan. See, e.g., Aujame et al., Hum. Antibod. 8: 155-168, 1997; Barbas et al., Proc. Natl. Acad. Sci. USA 88: 7978-82, 1991; Barbas et al., Proc. Natl. Acad. Sci. USA 91: 3809-13, 1994; Boder et al., Proc. Natl. Acad. Sci. USA 97: 10701-10705, 2000; Crameri et al., Nat. Med. 2: 100-102, 1996; Fisch et al., Proc. Natl. Acad. Sci. USA 93: 7761-7766, 1996; Glaser et al., J. Immunol. 149: 3903-3913, 1992; Irving et al., Immunotechnology, 2: 127-143, 1996; Kanppik et al., J. Mol. Biol., 296: 57-86, 2000; Low et al., J. Mol. Biol. 260: 359-368, 1996; Riechmann and Winter, Proc. Natl. Acad. Sci. USA, 97: 10068-10073, 2000; and Yang et al., J. Mol. Biol. 254: 392-403, 1995.

In another aspect, the invention provides vectors configured for the propagation of rgps displaying a polypeptide of interest. Such vectors comprise a nucleic acid (sometimes referred to as a sequence) encoding an a full length or truncated rgps package surface protein, a nucleic acid segment (sometimes referred to as a sequence) encoding an in-frame introduced proteolytic cleavage site, and a cloning site for introduction of a polypeptide segment (sometimes referred to as a sequence) of interest as a continuous open reading frame that includes the package surface protein sequence and the proteolytic cleavage site sequence. Such vectors also comprise suitable one or more regulatory sequences also known as regulatory elements for providing expression of the continuous open reading frame in an appropriate host cell.

In certain embodiments, the vectors of the present invention are phage display vectors encoding a full length or truncated bacteriophage coat protein as the package surface protein. More preferably, the bacteriophage is a filamentous bacteriophage, and most preferably is M13, fd, f1, or engineered variants thereof.

In particularly preferred embodiments, the vectors of the present invention comprise a nucleic acid encoding a full length or truncated form of gene III from a filamentous bacteriophage; a nucleic acid encoding an introduced proteolytic cleavage site in frame with the gene III sequence; and a nucleic acid providing a cloning site for introduction of a polypeptide sequence of interest as an open reading frame with the gene III sequence and the proteolytic cleavage site sequence. A nucleic acid encoding proteolytic cleavage site is in-frame with the gene III sequence when the two can be expressed as a fusion protein comprising protein III fused to the proteolytic cleavage site. The open reading frame is operably linked to regulatory sequences providing expression of the open reading frame when introduced into a host bacterial cell. In various embodiments, such nucleic acid sequences may be provided as part of a bacteriophage genome for packaging of the bacteriophage and display of the polypeptide of interest. Alternatively, such sequences may be provided as part of a phagemid for use in “two vector” phage packaging systems.

In preferred embodiments, the proteolytic cleavage site is a cleavage site for a proteolytic enzyme selected from the group consisting of factor Xa, enterokinase, thrombin, tobacco etch virus protease, and human rhinovirus 3C protease. In yet other preferred embodiments, the proteolytic cleavage site is a cleavage site selected from the group consisting of IEGR, DDDDK, LVPRGS, ENLYFQG, and LEVLFQGP.

In another object of the invention, compositions and methods are provided to efficiently express a recombinant gene product on the surface of filamentous phage. Taking advantage of the domain structure of the pIII protein, a modified coat protein is provided that deletes either the complete N1 or N2 domain. The N1 or N2 is considered to be completely deleted when at least 90% and preferably 100% of the residues in a naturally occurring N1 or N2 domain are deleted. Thus, an N1/C or N2/C construct is used as an anchor to display a desired polypeptide as a fusion protein on the surface of bacteriophage particles. By reducing the size of the pIII protein, the methods and compositions described herein can reduce the energetic demands on the phage-producing cells, and can minimize steric effects of other bacteriophage coat proteins on accessing (e.g., for binding and selection) the displayed polypeptide of interest.

In a first aspect, the present invention provides a filamentous phage encapsulating a genome encoding a polypeptide comprising: a first segment (also referred to as a sequence) of amino acids to be displayed on the surface of phage particles, the first segment comprising or consisting entirely of residues heterologous to the filamentous phage, wherein the first segment is fused to a second segment of amino acids comprising or consisting of either the N1 or N2 domain of a pIII protein but not both, and wherein the second segment is fused (directly or via a linker of from 1-60 amino acids) to a third segment of amino acids comprising or consisting of the C domain of the pIII protein. In a related aspect, the present invention provides a library of such filamentous phage encoding a plurality of first segments.

In various preferred embodiments, the linker between the N1 and C domains or the N2 and C domains is at least 5 amino acids in length, more preferably at least 10 amino acids in length, still more preferably at least 20 amino acids in length, yet more preferably at least 30 amino acids in length, and most preferably between 40 and 60 amino acids in length. In particularly preferred embodiments, the linker comprises peptide segments (sometimes referred to as sequences) selected from the L1 and/or L2 glycine-rich linker peptides of the pIII protein. Examples of such linkers are provided herein.

In other preferred embodiments, the filamentous phage encapsulates a genome further encoding a secretion signal peptide (sometimes referred to as a signal sequence) operatively linked to the amino terminus of the sequence of amino acids to be displayed on the surface of phage particles, which is itself fused to the modified pIII coat protein as described above. Suitable eukaryotic and prokaryotic signal sequences are known to those of skill in the art, and exemplary signal sequences are described hereinafter.

In certain embodiments, the sequence of amino acids to be displayed on the surface of phage particles comprises amino acids encoding all or a portion of an antibody molecule. Preferred sequences comprise a portion or all of at least one antibody variable domain capable of specifically binding to an antigen (referred to in the art as V_{L} and V_{H}, corresponding to the variable domains of light and heavy antibody chains), and most preferably comprise a portion or all of an antibody variable domain and a portion or all of an antibody constant domain (referred to in the art as CL and CH, corresponding to the constant domains of light and heavy antibody chains). Antibodies can be displayed on the surface of phage in a variety of formats, for example as Fab molecules or single-chain constructs. Exemplary antibody display sequences are described hereinafter.

In the case that a multichain protein is to be displayed on the surface of phage particles, the genome may further comprise a sequence of amino acids (i.e., a polypeptide) to be expressed operably linked to a secretion signal sequence. For example, in Fab phage display, the antibody heavy (or light) chain may be displayed on the surface of phage particles by expression as a fusion to the modified pIII coat protein, and the antibody light (or heavy) chain may be expressed as a separate polypeptide operably linked to an appropriate signal sequence. Exemplary sequences for such multichain display are described hereinafter.

In these and other embodiments, the sequence of amino acids to be displayed on the surface of phage particles can comprise amino acids encoding one or more tag sequences. Such tag sequences can facilitate purification of fusion proteins using commercially available affinity matrices. Such tag sequences include, but are not limited to, glutathione S-transferase (GST), maltose binding protein (MBP), thioredoxin (Trx), calmodulin binding peptide (CBP), poly-His, FLAG, c-myc, and hemagglutinin (HA). GST, MBP, Trx, CBP, and poly-His enable purification of their cognate fusion proteins on immobilized glutathione, maltose, phenylarsine oxide, calmodulin, and metal-chelate resins, respectively. FLAG, c-myc, and hemagglutinin (HA) enable immunoaffinity purification of fusion proteins using commercially available monoclonal and polyclonal antibodies that specifically recognize these epitope tags. Other suitable tag sequences will be apparent to those of skill in the art. Additionally or in the alternative, the sequence of amino acids to be displayed on the surface of phage particles can comprise amino acids encoding a protease cleavage site as described above.

In another aspect, the invention provides vectors configured for the propagation of filamentous phage encapsulating a genome encoding a polypeptide comprising: a first segment of amino acids to be displayed on the surface of phage particles, the first segment being heterologous to the filamentous phage, wherein the first segment is fused to a second segment of amino acids comprising or consisting or either the N1 or N2 domain of a pIII protein but not both, and wherein the second segment is fused (directly or via a linker of from 1-60 amino acids) to a third segment of amino acids comprising or consisting of the C domain of the pIII protein. Such vectors comprise suitable regulatory sequences for providing expression of the fusion proteins described above in an appropriate host cell operably linked to the fusion protein sequence. Suitable vectors include, but are not limited to, both bacteriophage genomes and phagemids. Such vectors may further comprise sequences encoding one or more tag sequences, signal sequences, etc., as described herein. In related aspects, vectors may be provided that comprise a cloning site, most preferably a multiple cloning site, at a position N-terminal to a first segment of amino acids comprising or consisting of either the N1 or N2 domain but not both of a pIII protein, wherein the first segment is fused (directly or via a linker of from 1-60 amino acids) to a second segment of amino acids comprising or consisting of the C domain of the pIII protein. Such vectors can provide for convenient insertion of heterologous sequences into the cloning site for display as fusion proteins on filamentous phage.

In the case that a multichain protein is to be displayed on the surface of phage particles, the vector may further comprise additional regulatory sequences for providing expression of the polypeptide chain(s) not expressed as a fusion to the modified pIII coat protein operably linked to the appropriate protein sequence(s). For example, in Fab phage display, vector may be configured to express the antibody heavy (or light) chain on the surface of phage particles by expression as a fusion to the modified pIII coat protein, and the antibody light (or heavy) chain may be expressed as a separate polypeptide from the same vector. Exemplary vectors for such multichain display are described hereinafter.

In related aspects, the present invention relates to methods for the display of polypeptides of interest as fusion proteins on filamentous phage, wherein the fusion protein comprises: a first segment of amino acids heterologous to the filamentous phage, wherein the first segment is fused to a second segment of amino acids comprising or consisting of either the N1 or N2 domain but not both of a pIII protein, and wherein the second segment is fused (directly or via a linker of from 1-60 amino acids) to a third segment of amino acids comprising or consisting of the C domain of the pIII protein. Such methods comprise expressing from host cells a bacteriophage population comprising such fusion proteins. Expression of the bacteriophage population may rely on the bacteriophage genome for packaging of the bacteriophage and display of the fusion protein of interest. Alternatively, phagemid/helper phage and other “two vector” phage packaging systems are also within the scope of the present invention.

In certain embodiments, the methods described herein further comprise one or a plurality of enrichment steps, which increases the proportion of bacteriophage displaying a polypeptide of interest. Such methods, which preferably employ binding to an affinity binding partner for the polypeptide of interest, are well known in the art. As discussed above, such enrichment steps may comprise contacting the bacteriophage population with one or more proteolytic enzyme(s) used to remove at least a portion of the displayed polypeptide(s) of interest.

### BRIEF DESCRIPTION OF THE FIGURES

FIG. 1 shows an exemplary standard curve for converting a signal measured in an ELISA assay to a bacteriophage titer.

FIG. 2 shows an exemplary change in titer obtained by proteolysis of a bacteriophage vector according to the methods described herein.

FIG. 3 shows the pIII protein of M13. From N terminus-to-C terminus, the signal sequence (residues 1-18) is shown as italicized text; N1 (residues 19-85) is shown as bold text; glycine rich linker L1 (residues 86-104) is shown as underlined text; N2 (residues 105-235) is shown as bold italicized text; glycine rich linker L2 (residues 236-274) is shown as underlined italicized text; and C (residues 275-424) is shown as normal text.

### DETAILED DESCRIPTION OF THE INVENTION

The present invention relates in part to novel polypeptide display methods, and to display vectors configured for efficient use in such methods.

In particular, the present invention provides methods and compositions that can overcome a loss in function that occurs upon display of polypeptides as fusion proteins with surface proteins of replicable genetic packages. As described herein, the displayed polypeptide of interest is available for the purpose of selecting and enriching those rgps exhibiting a desired binding interaction that is mediated by the displayed polypeptide. After such an enrichment step, the deleterious effects on rgps function caused by display of the polypeptide (e.g., a loss or reduction in bacteriophage infectivity) may then be reduced or eliminated by proteolysis at a site that is either naturally occurring in the fusion protein or that is introduced into the fusion protein using recombinant DNA methodology. By removing all or a portion of the displayed polypeptide, but leaving sufficient surface protein sequences to support propagation of the proteolyzed rgps, the desired rgps may be efficiently and rapidly enriched using standard phage display methodology. A portion of the displayed polypeptide means at least 1, 5, 10 or 25 amino acids, and optionally, at least 25%, 50%, 75% or 100% of the displayed polypeptide (not including the rgp protein to which it is fused).

A. Replicable Genetic Packages

The term “replicable genetic package” or “rgps” as used herein refers to a cell, spore or virus. The replicable genetic package can be eucaryotic or procaryotic. A display library is formed by introducing nucleic acids encoding exogenous polypeptides to be displayed into the genome of the replicable genetic package to form a fusion protein with an endogenous protein that is normally expressed from the outer surface of the replicable genetic package, referred to herein as a “package surface protein.” Expression of the fusion protein, transport to the outer surface and assembly results in display of exogenous polypeptides from the outer surface of the genetic package.

The genetic packages most frequently used for display libraries are bacteriophage, particularly filamentous phage, and especially phage M13, Fd and F1 and engineered variants (i.e., versions derived from the parent bacteriophage modified using recombinant DNA methodology). Most work has inserted libraries encoding polypeptides to be displayed into either gIII or gVIII of these phage, forming a fusion protein. See, e.g., Dower, WO 91/19818; Devlin, WO 91/18989; MacCafferty, WO 92/01047 (gene III); Huse, WO 92/06204; Kang, WO 92/18619 (gene VIII). Such a fusion protein typically comprises a signal sequence, usually from a secreted protein other than the phage coat protein, a polypeptide to be displayed and either the gene III or gene VIII protein or a fragment thereof effective to display the polypeptide. The gene III or gene V III protein used for display is preferably from (i.e., homologous to) the phage type selected as the display vehicle. Exogenous coding sequences are often inserted at or near the N-terminus of gene III or gene v III although other insertion sites are possible.

Some filamentous phage vectors have been engineered to produce a second copy of either gene III or gene VIII. In such vectors, exogenous sequences are inserted into only one of the two copies. Expression of the other copy effectively dilutes the proportion of fusion protein incorporated into phage particles and can be advantageous in reducing selection against polypeptides deleterious to phage growth. In another variation, exogenous polypeptide sequences are cloned into phagemid vectors which encode a phage coat protein and phage packaging sequences but which are not capable of replication. Phagemids are transfected into cells and packaged by infection with helper phage. Use of phagemid system also has the effect of diluting fusion proteins formed from coat protein and displayed polypeptide with wildtype copies of coat protein expressed from the helper phage. See, e.g., Garrard, WO 92/09690.

Eucaryotic viruses can also be used to display polypeptides in an analogous manner. For example, display of human heregulin fused to gp70 of Moloney murine leukemia virus has been reported by Han et al., Proc. Natl. Acad. Sci. USA 92: 9747-9751, 1995. Spores can also be used as replicable genetic packages. In this case, polypeptides are displayed from the outersurface of the spore. For example, spores from B. subtilis have been reported to be suitable. Sequences of coat proteins of these spores are provided by Donovan et al., J. Mol. Biol. 196: 1-10, 1987. Cells can also be used as replicable genetic packages. Polypeptides to be displayed are inserted into a gene encoding a cell protein that is expressed on the cells surface. Bacterial cells including Salmonella typhimurium, Bacillus subtilis, Pseudomonas aeruginosa, Vibrio cholerae, Klebsiella pneumonia, Neisseria gonorrhoeae, Neisseria meningitidis, Bacteroides nodosus, Moraxella bovis, and especially Escherichia coli are preferred. Details of outersurface proteins are discussed by U.S. Pat. No. 5,571,698, and Georgiou et al., Nat. Biotechnol. 15: 29-34, 1997 and references cited therein. For example, the lamB protein of E. coli is suitable.

Yeast display libraries have also been described. See, e.g., Boder and Wittrup, Nat. Biotechnol. 15:553-7, 1997. Yeast surface expression systems can be used to express recombinant proteins on the surface of S. cerevisiae as a fusion with the a-agglutinin yeast adhesion receptor. Yeast expression can provide correct post-translational modification, processing and folding of mammalian proteins, coupled with rapid characterization of binding affinities of interacting proteins. The expressed fusion proteins can also contain c-myc and HA tag sequences, allowing quantification of the library surface expression by flow cytometry.

B. Proteolytic Enzymes

The term “proteolytic enzyme” or “protease” as used herein refers to an enzyme that hydrolyzes one or more peptide bonds in a polypeptide. An extensive list of proteolytic enzymes is known to those of skill in the art. The following list of proteolytic enzymes is not meant to be limiting:

| | |
|---|---|
| Achromopeptidase | Aminopeptidase |
| Ancrod | Angiotensin Converting |
| | Enzyme |
| Bromelain | Calpain |
| Calpain I | Calpain II |
| Carboxypeptidase A | Carboxypeptidase B |
| Carboxypeptidase G | Carboxypeptidase P |
| Carboxypeptidase W | Carboxypeptidase Y |
| Caspase | Caspase 1 |
| Caspase 2 | Caspase 3 |
| Caspase 4 | Caspase 5 |
| Caspase 6 | Caspase 7 |
| Caspase 8 | Caspase 9 |
| Caspase 10 | Caspase 13 |
| Cathepsin B | Cathepsin C |
| Cathepsin D | Cathepsin G |
| Cathepsin H | Cathepsin L |
| Chymopapain | Chymase |
| Chymotrypsin, a- | Clostripain |
| Collagenase | Complement C1r |
| Complement C1s | Complement Factor D |
| Complement factor I | Cucumisin |
| Dipeptidyl peptidase IV | Elastase, leukocyte |
| Elastase, pancreatic | Endoproteinase Arg-C |
| Endoproteinase Asp-N | Endoproteinase Glu-C |
| Endoproteinase Lys-C | Enterokinase |
| Factor Xa | Ficin |
| Furin | Granzyme A |
| Granzyme B | HIV Protease |
| IGase | Kallikrein tissue |
| Leucine Aminopeptidase (General) | Leucine aminopeptidase, |
| | cytosol |
| Leucine aminopeptidase, microsomal | Matrix metalloprotease |
| Methionine Aminopeptidase | Neutrase |
| Papain | Pepsin |
| Plasmin | Prolidase |
| Pronase E | Prostate Specific Antigen |
| Protease, Alkalophilic from Streptomyces | Protease from Aspergillus |
| griseus | |
| Protease from Aspergillus saitoi | Protease from Aspergillus |
| | sojae |
| Protease (B. licheniformis) (Alkaline) | Protease (B. licheniformis) |
| | (Alcalase) |
| Protease from Bacillus polymyxa | Protease from Bacillus sp |
| Protease from Bacillus sp (Esperase) | Protease from Rhizopus sp. |
| Protease S | Proteasomes |
| Proteinase from Aspergillus oryzae | Proteinase 3 |
| Proteinase A | Proteinase K |
| Protein C | Pyroglutamate aminopeptidase |
| Renin | Rennin |
| Streptokinase | Subtilisin |
| Thermolysin | Thrombin |
| Tissue Plasminogen Activator | Trypsin |
| Tryptase | Urokinase |

Selection of a particular protease for use in the methods described herein may be performed empirically, e.g., by contacting rgps displaying a polypeptide of interest to one or more proteases and comparing the ability of the rgps of interest to propagate in host cells before and after the proteolysis step. Alternatively, or in addition to such empirical work, the sequence of the particular package surface protein being used for fusion protein display may be examined for known protease cleavage sites. Depending on the location of such sites in the package surface protein, certain proteolytic sites may be avoided, and/or others may be selected for use in the present methods.

While described herein in terms of enzymatic cleavage of the fusion protein, chemical proteolysis may also be employed, either instead of or together with appropriate enzymatic cleavage. The selection criteria for choosing one or more cleavage conditions are that proteolysis increases the ability of the rgps displaying a fusion protein of interest to propagate in host cells.

Using pIII display as an example, preferably the proteolytic enzyme(s) used in the present invention cut the fusion protein at or near the N-terminus of pIII to release the fused polypeptide sequence, but retaining functional pIII-mediated infectivity. To ensure that a protease site is available in this location, a particular proteolytic cleavage site may be introduced, e.g., distal to, but most preferably within about 20 amino acids of, the final N-terminal residue of the full length or truncated pIII sequence being employed. As used herein, a proteolytic cleavage site is said to be “introduced” if it is does not occur naturally in the pIII sequence. Preferred proteolytic enzymes and their cleavage sites are described in the following table:

| | Cleavage | |
|---|---|---|
| | Enzyme/Self- | |
| Excision site ↓ | Cleavage | Comments |
| Asp—Asp—Asp—Asp— | Enterokinase | The site will not cleave if |
| Lys↓ | | followed by a proline |
| | | residue. |
| | | Secondary cleavage sites at |
| | | other basic residues, |
| | | depending on conformation |
| | | of protein substrate. Active |
| | | from pH 4.5 to 9.5 and |
| | | between 4° C. and 45° C. |
| Ile—Glu/Asp—Gly—Arg↓ | Factor Xa | Will not cleave if |
| | protease | followed by proline and |
| | | arginine. Secondary |
| | | cleavage sites following |
| | | Gly—Arg sequences. |
| Leu—Val—Pro— | Thrombin | Secondary cleavage sites. |
| Arg↓Gly—Ser | | |
| Glu—Asn—Leu—Tyr— | TEV protease | Seven-residue recognition |
| Phe—Gln↓Gly | | site, making it a highly |
| | | site-specific protease. |
| | | Active over a wide range of |
| | | temperatures. Protease |
| | | available as a His-tag |
| | | fusion, allowing for |
| | | protease removal after |
| | | combinant protein cleavage. |
| Leu—Glu—Val—Leu— | PreScission ™ | Genetically engineered |
| Phe—Gln↓Gly—Pro | protease | form of human rhinovirus |
| | | 3C protease with a GST |
| | | fusion, allowing for facile |
| | | cleavage and purification |
| | | of GST-tagged proteins |
| | | along with protease re- |
| | | moval after recombinant |
| | | protein cleavage. Enables |
| | | low-temperature cleavage |
| | | of fusion proteins contain- |
| | | ing the eight-residue |
| | | recognition sequence. |

Proteolytic cleavage conditions may be determined by incubating a particular rgps stock under an array of different conditions (temperatures, pH, salt concentrations, enzyme concentrations, times, etc.), with the value of particular conditions measured by the ability of the treated rgps to propagate in appropriate host cells, and exemplary conditions are described hereinafter in the Examples. RGPS propagation is expressed as the number of rgps produced by host cells in a particular reaction (e.g., infection of host cells with a population of bacteriophage). Such propagation measurements are often expressed as a “titer.” See, e.g., Ward et al., J. Immunol. Meth. 189: 73-82, 1996.

C. Displayed Polypeptides and Vectors

Nucleic acids encoding polypeptides to be displayed, proteolytic cleavage sites, etc., optionally flanked by spacers are inserted into the genome of a replicable genetic package, a phagemid vector, etc., as discussed above by standard recombinant DNA techniques (see generally, Sambrook et al., Molecular Cloning, A Laboratory Manual, 2d ed., Cold Spring Harbor Laboratory Press, Cold Spring Harbor, N.Y., 1989, incorporated by reference herein). The nucleic acids are ultimately expressed as polypeptides (with or without spacer or framework residues) fused to all or part of an outer surface protein of the replicable package.

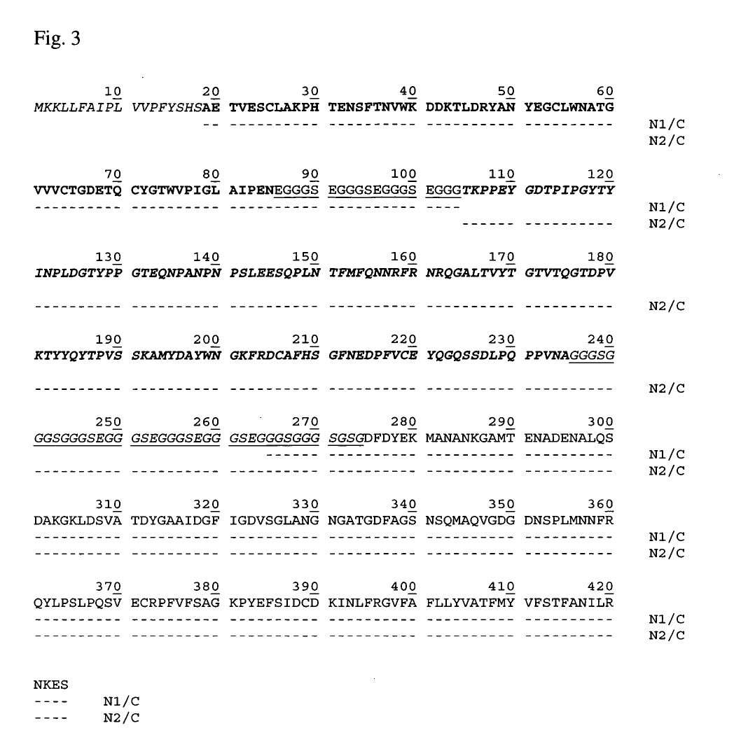

As discussed herein, preferred rgps are filamentous phage, and preferred truncated pIII proteins for use as anchors for display of polypeptides of interest as fusion proteins are referred to herein as “N1/C” and “N2/C” constructs. The domain structure of pIII from M13 (Swiss-Prot P69168) is shown in FIG. 3. From N terminus-to-C terminus, the signal sequence (residues 1-18) is shown as italicized text; N1 (residues 19-85) is shown as bold text; glycine rich linker L1 (residues 86-104) is shown as underlined text; N2 (residues 105-235) is shown as bold italicized text; glycine rich linker L2 (residues 236-274) is shown as underlined italicized text; and C (residues 275-424) is shown as normal text. Other pIII proteins from other filamentous phage are known in the art and have a similar domain structure.

The phrases “N1/C” and “N2/C” are not intended to imply that only pIII residues from N1 and C or N2 and C are present in the construct. Rather, the phrases are intended to indicate that, for N1/C, the N2 domain has been deleted in its entirety, and for N2/C, the N1 domain has been deleted in its entirety. Some or all residues from the glycine rich linkers may still be present, or may be deleted in their entirety, or may be replaced with or supplemented by residues that are heterologous to the pIII protein.

An exemplary M13 N1/C construct is depicted in FIG. 3. The sequences for this construct are underlined on the lines indicated by the label N1/C, and include residues 19-104, and 265-424. Thus, this construct includes a complete N1 domain, a complete L1, a partial L2, and a complete C domain. Likewise, an exemplary M13 N2/C construct is also depicted in FIG. 3. The sequences for this construct are underlined on the lines indicated by the label N1/C, and include residues 105-424. Thus, this construct includes a complete D2 domain, a complete L2, and a complete C domain. The N1 and/or N2 and C domains utilized may differ somewhat from the wild type domain sequences, so long as they are within 5% in length and are 95% identity across this length to the wild type domain sequence. Sequence identity is determined using the Basic Local Alignment Search Tool (BLAST) (Altschul, S. F. et al. (1990) J. Mol. Biol. 215:403-410, which is available from several sources, including the NCBI, Bethesda, Md., and on the Internet at world wide web ncbi.nlm.nih.gov/BLAST/ with gap and other parameters set to default settings.

One exemplary type of display vector that may be constructed comprises a full length or truncated form of gene III (thus encoding pIII), together with an introduced proteolytic cleavage site in frame with the gene III sequence and a cloning site into which sequences encoding a polypeptide of interest may be inserted. As described herein, a preferred site for introduction of the proteolytic cleavage site is distal to the amino terminus of the pIII protein (full length or truncated) and proximal to the cloning site, so that the proteolytic cleavage site will lie between the pIII residues and the residues encoding the polypeptide of interest. The first nucleotide encoding the proteolytic cleavage site is preferably within 60 nucleotides of the final pIII nucleotide, more preferably within 45 nucleotides, still more preferably within 30 nucleotides, and even more preferably within about 18 nucleotides.

Such vectors preferably place the open reading frame created by the (full length or truncated) gene III, proteolytic cleavage site, and cloning site nucleotides under operable control of sequences appropriate for expression of the open reading frame. Such regulatory sequences (also known as regulatory elements) are well known in the art. See, e.g., Jonasson et al., Biotechnol. Appl. Biochem. 35: 91-105, 2002. The term “cloning site” refers to a site cleavable by a restriction endonuclease, where the particular restriction endonuclease does not also cut within the pIII or proteolytic cleavage site nucleotides. Preferred cloning sites are “multiple cloning sites,” which refers to sites cleavable by at least two, more preferably at least 3, still more preferably at least 5, and more preferably at least 10 or more restriction endonucleases.

Polypeptides typically displayed from replicable genetic packages fall into a number of broad categories. One category is libraries of short random or semi random peptides. See, e.g., Cwirla et al., supra. The strategy here is to produce libraries of short peptides in which some or all of the positions are systematically varied for the different amino acids. Random peptide coding sequences can be formed by the cloning and expression of randomly-generated mixtures of oligonucleotides is possible in the appropriate recombinant vectors. See, e.g., Oliphant et al., Gene 44: 177-183, 1986. A second category of library comprises variants of a starting framework protein. See Ladner et al., supra. In this approach, a starting polypeptide which may be of substantial length is chosen and only selected positions are varied. The nucleic acid encoding the starting polypeptide can be mutagenized by, for example, insertion of mutagenic cassette(s) or error-prone PCR.

A third category of library consists of antibody libraries. Antibody libraries can be single or double chain. Single chain antibody libraries can comprise the heavy or light chain of an antibody alone or the variable domain thereof. However, more typically, the members of single-chain antibody libraries are formed from a fusion of heavy and light chain variable domains separated by a peptide spacer within a single contiguous protein. See e.g., Ladner et al., WO 88/06630; McCafferty et al., WO 92/01047. While expressed as a single protein, such single-chain antibody constructs can actually display on the surface of bacteriophage as double-chain or multi-chain proteins. See, e.g., Griffiths et al., EMBO J. 12: 725-34, 1993. Alternatively, double-chain antibodies may be formed by noncovalent association of heavy and light chains or binding fragments thereof. The diversity of antibody libraries can arise from obtaining antibody-encoding sequences from a natural source, such as a nonclonal population of immunized or unimmunized B cells. Alternatively, or additionally, diversity can be introduced by artificial mutagenesis as discussed for other proteins.

Double-chain and multi-chain display libraries represent a species of the display libraries discussed herein. Production of such libraries is described by, e.g., Dower, U.S. Pat. No. 5,427,908; Huse WO 92/06204; Huse, in Antibody Engineering, (Freeman 1992), Ch. 5; Kang, WO 92/18619; Winter, WO 92/20791; McCafferty, WO 92/01047; Hoogenboom WO 93/06213; Winter et al., Annu. Rev. Immunol. 12: 433-455, 1994; Hoogenboom et al., Immunol. Rev. 130: 41-68, 1992; Soderlind et al., Immunol. Rev 130: 109-124, 1992. In double-chain antibody libraries for example, one antibody chain is fused to a phage coat protein, as is the case in single chain libraries. The partner antibody chain is complexed with the first antibody chain, but the partner is not directly linked to a phage coat protein. Either the heavy or light chain can be the chain fused to the coat protein. Whichever chain is not fused to the coat protein is the partner chain. This arrangement is typically achieved by incorporating nucleic acid segments encoding one antibody chain gene into either gIII or gVIII of a phage display vector to form a fusion protein comprising a signal sequence (also known as a signal peptide), an antibody chain, and a phage coat protein. Nucleic acid segments encoding the partner antibody chain can be inserted into the same vector as those encoding the first antibody chain. Optionally, heavy and light chains can be inserted into the same display vector linked to the same promoter and transcribed as a polycistronic message. Alternatively, nucleic acids encoding the partner antibody chain can be inserted into a separate vector (which may or may not be a phage vector). In this case, the two vectors are expressed in the same cell (see WO 92/20791). The sequences encoding the partner chain are inserted such that the partner chain is linked to a signal sequence, but is not fused to a phage coat protein. Both antibody chains are expressed and exported to the periplasm of the cell where they assemble and are incorporated into phage particles.

Libraries often have sizes of about 10³, 10⁴, 10⁶, 10⁷, 10⁸ or more members. Exemplary vectors and procedures for cloning polypeptide chains into filamentous phage are described herein in the Examples.

D. Host Cells

The choice of expression vector depends on the intended host cells in which the vector is to be expressed. Typically, the vector includes a promoter and other regulatory sequences in operable linkage to the inserted coding sequences that ensure the expression of the latter. Use of an inducible promoter is advantageous to prevent expression of inserted sequences except under inducing conditions. Inducible promoters include arabinose, lacZ, metallothionein promoter or a heat shock promoter. Cultures of transformed organisms can be expanded under noninducing conditions without biasing the population for coding sequences whose expression products are better tolerated by the host cells. The vector may also provide a secretion signal sequence position to form a fusion protein with polypeptides encoded by inserted sequences, although often inserted polypeptides are linked to a signal sequences before inclusion in the vector. Vectors to be used to receive sequences encoding antibody light and heavy chain variable domains sometimes encode constant regions or parts thereof that can be expressed as fusion proteins with inserted chains thereby leading to production of intact antibodies or fragments thereof.

E. coli is one prokaryotic host useful particularly for cloning the polynucleotides of the present invention. Other microbial hosts suitable for use include bacilli, such as Bacillus subtilis, and other enterobacteriaceae, such as Salmonella, Serratia, and various Pseudomonas species. In these prokaryotic hosts, one can also make expression vectors, which will typically contain expression control sequences compatible with the host cell (e.g., an origin of replication). In addition, any number of a variety of well-known promoters will be present, such as the lactose promoter system, a tryptophan (trp) promoter system, a beta-lactamase promoter system, or a promoter system from phage lambda. The promoters typically control expression, optionally with an operator sequence, and have ribosome binding site sequences and the like, for initiating and completing transcription and translation.

Other microbes, such as yeast, are also be used for expression. Saccharomyces is a preferred host, with suitable vectors having expression control sequences, such as promoters, including 3-phosphoglycerate kinase or other glycolytic enzymes, and an origin of replication, termination sequences and the like as desired.

Mammalian tissue cell culture can also be used to express and produce the polypeptides of the present invention (see Winnacker, From Genes to Clones (VCH Publishers, N.Y., N.Y., 1987). A number of suitable host cell lines capable of secreting intact immunoglobulins have been developed including insect cells for baculovirus expression, CHO cell lines, various Cos cell lines, HeLa cells, myeloma cell lines, transformed B-cells and hybridomas. Expression vectors for these cells can include expression control sequences, such as an origin of replication, a promoter, and an enhancer (Queen et al., Immunol. Rev. 89: 49-68 (1986)), and necessary processing information sites, such as ribosome binding sites, RNA splice sites, polyadenylation sites, and transcriptional terminator sequences. Preferred expression control sequences are promoters derived from immunoglobulin genes, SV40, adenovirus, bovine papilloma virus, or cytomegalovirus.

Methods for introducing vectors containing the polynucleotide sequences of interest vary depending on the type of cellular host. For example, calcium chloride transfection is commonly utilized for prokaryotic cells, whereas calcium phosphate treatment or electroporation may be used for other cellular hosts. (See generally Sambrook et al., supra).

E. Selection for Affinity to Target

Displayed library members may be enriched for polypeptides exhibiting a binding interaction of interest by screening for binding to a target. The target can be any molecule of interest for which it is desired to identify binding partners. The library members are contacted with the target, which may be labeled (e.g., with biotin) in such a manner that allows its immobilization. Binding is allowed to proceed to equilibrium and then target is brought out of solution by contacting with the solid phase in a process known as panning (Parmley and Smith, Gene 73: 305-318, 1988). Library members that remain bound to the solid phase throughout the selection process do so by virtue of bonds between them and immobilized target molecules. Unbound library members are washed away from the solid phase.

Usually, library members are subject to amplification before performing a subsequent round of screening. Often, bound library members can be amplified without dissociating them from the support. For example, gene VIII phage library members immobilized to beads, can be amplified by immersing the beads in a culture of E. coli. Likewise, bacterial display libraries can be amplified by adding growth media to bound library members. Alternatively, bound library members can be dissociated from the solid phase (e.g., by change of ionic strength or pH) before performing subsequent selection, amplification or propagation.

In certain embodiments, bound library members may be enriched for one or both of the following features after affinity selection: multivalent display of polypeptides and display of polypeptides having specific affinity for the target of interest. After subsequent amplification to produce a secondary library, the secondary library remains enriched for display of polypeptides having specific affinity for the target, but, as a result of amplification, is no longer enriched for polyvalent display of polypeptides. Thus, a second cycle of polyvalent enrichment can then be performed, followed by a second cycle of affinity enrichment to the screening target. Further cycles of affinity enrichment to the screening target, optionally, alternating with amplification and enrichment for polyvalent display can then be performed, until a desired degree of enrichment has been performed.

In a variation, affinity screening to a target is performed in the presence of a compound for which binding is to be avoided (for example, a molecule that resembles but is not identical to the target). Such screening preferentially selects for library members that bind to a target epitope not present on the compound. In a further variation, bound library members can be dissociated from the solid phase in competition with a compound having known crossreactivity with a target for an antigen. Library members having the same or similar binding specificity as the known compound relative to the target are preferentially eluted. Library members with affinity for the target through an epitope distinct from that recognized by the compound remain bound to the solid phase.

Enriched libraries produced by the above methods are characterized by a high proportion of members encoding polypeptides having specific affinity for the target. For example, at least 10, 25, 50, 75, 95, or 99% of members encode polypeptides having specific affinity for the target. The exact percentage of members having affinity for the target depends whether the library has been amplified following selection, because amplification increases the representation of genetic deletions. However, among members with full-length polypeptide coding sequences, the proportion encoding polypeptides with specific affinity for the target is very high (e.g., at least 50, 75, 95 or 99%). Not all of the library members that encode a polypeptide with specific affinity for the target necessarily display the polypeptide. For example, in a library in which 95% of members with full-length coding sequences encode polypeptides with specific affinity for the target, usually fewer than half actually display the polypeptide. Usually, such libraries have at least 4, 10, 20, 50, 100, 1000, 10,000 or 100,000 different coding sequences. Usually, the representation of any one such coding sequences is no more than 50%, 25% or 10% of the total coding sequences in the library.

F. Characteristics of Libraries

The above methods result in novel libraries of nucleic acid sequences encoding polypeptides having specific affinity for a chosen target. The libraries of nucleic acids typically have at least 5, 10, 20, 50, 100, 1000, 10⁴ or 10⁵ different members. Usually, no single member constitutes more than 25 or 50% of the total sequences in the library. Typically, at least 75, 90, 95, 99 or 99.9% of library members encode polypeptides with specific affinity for the target molecules. The nucleic acid libraries can exist in free form, as components of any vector or transfected as a component of a vector into host cells.

The nucleic acid libraries can be expressed to generate polyclonal libraries of antibodies or other polypeptides having specific affinity for a target. The composition of such libraries is determined from the composition of the nucleotide libraries. Thus, such libraries typically have at least 5, 10, 20, 50, 100, 1000, 10⁴ or 10⁵ members with different amino acid composition. Usually, no single member constitutes more than 25 or 50% of the total polypeptides in the library. In some libraries, at least 75, 90, 95, 99 or 99.9% of polypeptides have specific affinity for the target molecules. The different polypeptides differ from each other in terms of fine binding specificity and affinity for the target.

### EXAMPLES

The following examples serve to illustrate the present invention. These examples are in no way intended to limit the scope of the invention.

### Example 1

### Materials

The following materials are used in the following methods: E. coli strains (JM109, CJ236, DH12S), 3.0 μM streptavidin magnetic latex (M280,Dynal Biotech), thrombin (Novagen), 2xYT, 10× thrombin digestion buffer (200 mM Tris-HCl, pH 8.4, 1.5M NaCl, 25 mM CaCl₂), PEG/NaCl solution (30% PEG6000, 3M NaCl), panning buffer (Tris 40 mM, 150 mM NaCl, 20 mg/ml BSA, 0.1% Tween20, pH 7.5), elution buffer (0.1M glycine buffer pH 2.0), Roche complete protease inhibitor cocktail EDTA-free, goat anti-murine K-biotin (Southern Biotech), sheep anti-geneVIII-biotin (Seramune, biotinylated at Biosite as described in Example 10 of U.S. Pat. No. 6,057,098), reduced ampletamine-BSA-Biotin (“rMET-BSA-Biotin,” prepared as described in Example 4 of U.S. Patent Publication 20030162249), mutagenic oligonucleotide #1823 5′Phos-CAGACAAGCACTAGTAGAA CCACGCGGAACCAGAGAACCGCCACCAGTGCCACCGCCAGAATCCCTGGGCAC.

### Example 2

### Selection of Proteases and Proteolytic Cleavage Sites

The selection of an appropriate protease for use in the procedures described herein was achieved by a combination of the following procedures. The use of a program such as ‘peptidecutter’ which predicts potential protease and cleavage site in a given protein sequence (http://kr.expasy.org/tools/peptidecutter/) was used on the M13 coat proteins pIII and pVIII. The artisan may also compare pVI, pVII, and pIX). Potential sites for other proteases of interest that are not part of the ‘peptidecutter’ database may be checked by manually inspecting the coat protein sequences. From this analysis, thrombin was chosen as the cleavage enzyme, as no throbin cleavage sites were identified in the pIII or pVIII sequences.

If there remain doubts whether a protease would act on a phage in a deleterious manner, the artisan may incubate phage under the appropriate reaction conditions with the protease in question. Preferably, one then looks at a matrix evaluating several enzyme concentrations, temperatures, and incubation times. Host cells are then infected with the identical numbers of treated phage and then count the resulting plaque forming units that are the result of a productive infection event. See, e.g., Ward et al., J. Immunol. Meth. 189: 73-82, 1996, the contents of which are incorporated by reference herein in their entirety, including all tables, figures, and claims. An appropriate protease would not result in any difference in pfu versus an untreated sample of phage.

### Example 2

### Display Vector Preparation

A type 3 phage-display vector displaying a murine anti-rMET Fab, Fdcox24.6, was chosen as a model system. This vector has the carboxy-terminus of the heavy chain domain CH₁ fused to the 7^{th} amino acid of mature gene III (Dower, EP 0527839, the contents of which are incorporated by reference herein in their entirety, including all tables, figures, and claims). DNA encoding a peptide linker (GGGTGGGS) followed by a thrombin recognition site (LVPRGS) was introduced into Fdcox24.6 DNA between the carboxy terminus of the heavy chain and the 7^{th} amino acid of mature gene III by mutagenesis (Kunkel, U.S. Pat. No. 4,873,192, the contents of which are incorporated by reference herein in their entirety, including all tables, figures, and claims) using Fdcox24.6 uracil template made in CJ236 and oligonucleotide #1823. The completed mutagenesis reaction was electroporated into E. coli strain DH12S (Invitrogen). Incorporation of the correct sequence into Fdtet24.6T was verified by DNA sequencing.

### Example 3

### Analysis of Bacteriophage Infectivity

Fdcox24.6T was grown overnight in 50 ml of 2xYT (20 μg/ml tet) at 30° C., with shaking. This culture was used at a 1/100 dilution to inoculate 500 ml of 2xYT (20 μg/ml tet). After overnight growth at 30° C., with shaking, the bacterial cells were pelleted by centrifugation and the clarified supernatant containing Fdcox24.6T phage (presenting murine Fab) was harvested by centrifugation. The Fdcox24.6T phage was precipitated from 140 ml of clarified supernatant by the addition of ⅕ volume of a PEG/NaCl solution. After incubation at 4° C. for one hour, the phage were pelleted by centrifugation and thoroughly resuspended in 1.0 ml of PBS. The sample was centrifuged to pellet residual bacterial debris and the phage containing supernatant transferred to a fresh tube and stored at 4° C. A titer was determined by the following ELISA assay since the low infectivity of the fusion phage does not produce visible plaques when plated on an appropriate E. coli lawn.

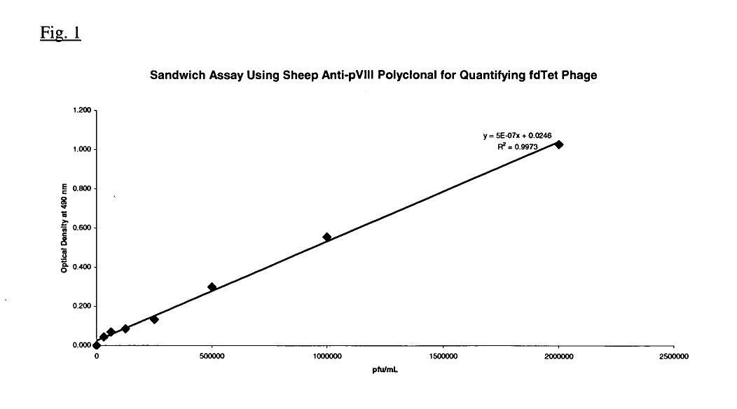

A phage stock of the parental (non-fusion) vector fdTet (ATCC, cat#37000) was grown and titered by serial dilution and plating on F′-containing bacterial lawn and found to have a titer of 2.25×10⁹ pfu/ml. Serial dilutions of this phage stock were used to generate a standard curve in a sandwich ELISA using a sheep anti-pVIII-biotin capture reagent and sheep anti-pVIII-alkaline phosphatase (AP) detection reagent in an avidin coated microtiter plate. A standard curve (FIG. 1) was generated. This standard curve relates an ELISA signal to phage concentration (pfu/ml).

Using this same assay and the fdTet standard curve, the titer of the phage Fd.cox.24.6T (which displays an anti-rMet10 Fab) stock solution was determined to be 5.0×10¹⁰ pfu/ml.

The clarified, PEG precipitated phage stock (800 μL) was prepared for selection of Fab displaying phage by the addition of BSA to 10 mg/ml. rMET-BSA-biotin was added to a final concentration of 5×10⁻⁸M (effective rMET concentration) and incubated overnight at 4° C. One mL (1% solids) of 3 μm streptavidin magnetic latex (Dynal Biotech) was placed in a magnetic separator. After the magnetic latex had been pulled to the side of the tube, the solution was carefully aspirated. The latex was resuspended in 400 μL of panning buffer and added to the phage stock, thoroughly mixed, and incubated at room temperature for 10 minutes. The solution was placed in a magnetic separator. After the magnetic latex had been pulled to the side of the tube, the solution was carefully aspirated. The latex was resuspended in 1.0 mL of panning buffer, transferred to a fresh microfuge tube, and placed back on the magnet. The latex was washed as above two additional times with panning buffer. The phage were eluted by resuspending the magnetic latex in 1.0 mL of elution buffer and incubating for 5 minutes at room temperature. The magnetic latex was pelleted by centrifugation, the clarified supernatant transferred to a fresh microfuge tube, and the elution process repeated one more time on the pelleted magnetic latex. The clarified supernatants containing the eluted phage were pooled and centrifuged at 14,000×rpm for 5 minutes to pellet any remaining magnetic latex. The supernatant was carefully transferred to a fresh tube and neutralized by the addition of 100 μL of 1M TRIS, pH 7.2. The Fd.cox.24.6T phage was precipitated by the addition of ⅕ volume of a PEG/NaCl solution. After incubation at 4° C. overnight, the phage were pelleted by centrifugation and thoroughly resuspended in 500 μL of thrombin digestion buffer.

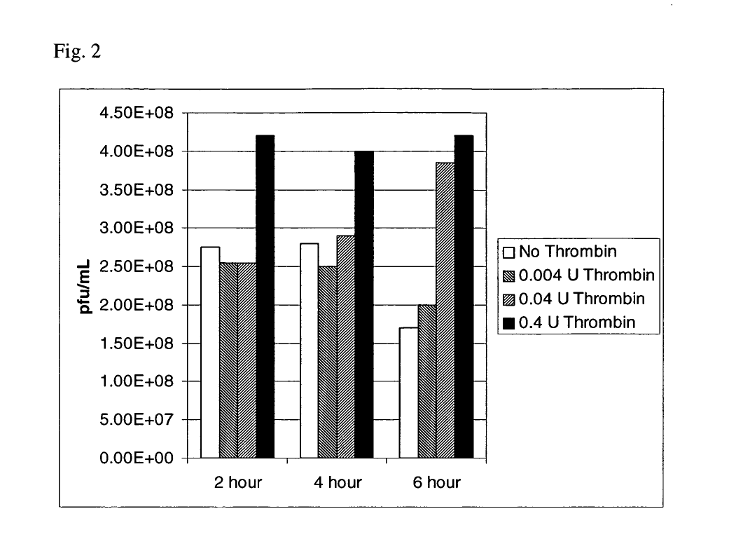

The Fd.cox.24.6T phage sample in thrombin cleavage buffer was aliquoted into four 100 μL samples. Samples 1 through 4 were adjusted to a final thrombin concentration of 0, 4.0×10^{-3, 4.0×10}⁻², and 4.0×10⁻¹ units/mL, respectively. The samples were incubated at 30° C. Aliquots (25 μL) were taken from each sample at 2, 4, and 6 hours, and transferred to microfuge tubes and additional thrombin protease activity stopped by the addition of 1 μL of a 25× protease inhibitor cocktail (Roche Complete EDTA-free). Panning buffer (25 μL) was added and the samples stored at 4° C. As a direct test of increased ability to propagate (measured by infectivity in the case of bacteriophage), 200 μL of a 10⁻⁴ dilution of each phage sample was incubated, in duplicate, with 200 μL of an overnight culture of JM109 at 37° C. for 15 minutes (no shaking) and aliquots plated on LB tet (20 μg/mL) plates. After overnight incubation, the number of colonies for each condition were counted. The results indicate that thrombin digestion results in an increased efficiency of infection (FIG. 2). The digestion resulted in at least a 2-fold increase in the number of productive infections. The trends for the experiment indicate that fewer infective phage are produced when shorter incubation times and lower thrombin concentrations are used.

As a direct test of increased ability to propagate (measured by infectivity in the case of bacteriophage), 200 μl of a 10⁴ dilution of each phage sample was incubated, in duplicate, with 200 μl of an overnight culture of JM109 at 37° C. for 15 minutes (no shaking) and aliquots plated on LB tet (20 μg/ml) plates. After overnight incubation, the number of colonies for each condition were counted. The results indicate that thrombin digestion results in an increased efficiency of infection (FIG. 2). The digestion resulted in at least a 2-fold increase in the number of productive infections. The trends for the experiment indicate that fewer infective phage are produced when lower temperature and thrombin concentrations are used.

The inclusion of a thrombin protease site between a protein (Fab) and a gene III fusion partner when digested by thrombin can increase the number of infective phage by up to two fold over an undigested sample. This additional step leads to greater selection efficiency while minimizing clonal selection.

### Example 4

### Analysis of Bacteriophage Infectivity with Thrombin Digestion Performed Directly on Phage Bound to Magnetic Latex

A PEG precipitated phage stock is prepared for selection of Fab-displaying phage as described in the previous example. Alternatively, a clarified phage stock can be directly prepared for selection of Fab displaying phage by the addition of BSA to a concentration of 10 mg/mL and the addition of 50 μL of 1M Tris, pH 8.0 per mL of clarified phage stock to adjust the pH. Streptavidin magnetic latex (3 μm, 1% solids, Dynal Biotech) prepared as previously described is added to the PEG-precipitated phage stock, thoroughly mixed, and incubated at room temperature for 10 minutes. The solution is placed in a magnetic separator. After the magnetic latex has been pulled to the side of the tube, the solution is carefully aspirated.

The latex is resuspended in 1.0 mL of panning buffer, transferred to a fresh microfuge tube, and placed back on the magnet. The latex is washed as above two additional times with panning buffer, followed by four washes with thrombin digestion buffer. After the last round of washing, the magnetic latex with bound Fd.cox.24.6T phage is resuspended in 500 μL of thrombin digest buffer. The phage sample in thrombin digest buffer is aliquoted into four, 100 μL samples. Samples 1 through 4 are adjusted to a final thrombin concentration of 0, 4.0×10⁻³, 4.0×10⁻², and 4.0×10⁻¹ units/mL, respectively. The samples are incubated at 30° C. (or other optimal temperature determined experimentally) with shaking. Aliquots (25 μL) are taken from each sample at 2, 4, and 6 hours, or other selected times and transferred to microfuge tubes. Thrombin activity is stopped by the addition of 1 μL of a 25× protease inhibitor cocktail (Roche Complete EDTA-free). Panning buffer (25 μL) is added, and the samples centrifuged at 20,000×g for 5 minutes. The supernatant containing phage (50 μL) is transferred to fresh tubes and stored at 4° C.

The samples are tested for increased ability to propagate (measured by infectivity in the case of bacteriophage) as described above. In duplicate, 200 μL of an appropriate dilution of each phage sample is incubated with 200 μL of an overnight culture of JM109 at 37[ ]C for 15 minutes (no shaking) and aliquots plated on LB tet (20 μg/mL) plates. After overnight incubation, the number of colonies for each condition are counted.

In the event of successful thrombin cleavage, the phage are no longer be specifically associated with the magnetic latex and should be in the supernatant. If the Fab is not cleaved from the gene III protein, the phage should still be associated with the magnetic latex via the biotinylated rMET-BSA-biotin reagent and should reside with the magnetic latex pellet.

The inclusion of a thrombin protease site between a protein (Fab) and a gene III fusion partner when digested by thrombin directly on the magnetic latex can increase the recovery of infective phage by up to ten fold over an undigested sample. This additional step leads to greater selection efficiency while minimizing clonal selection.

### Example 5

### Preparation of Gene III N2/C Phage Display Vector

The antibody phage display vector BS45, which is described in Example 5 of U.S. Pat. No. 6,057,098, the contents of which are incorporated by reference herein in their entirety, including all tables, figures, and claims, is used as the starting vector for inserting the M13 gene III sequence to the poly-histidine sequence at the C-terminus of the constant region of the heavy chain. The gene III sequence is cloned over the pseudo gene VIII sequence in BS45. Domains N2 and C and linker L2 of Gene III (amino acids 105-424, Beck and Zink, Gene 16, 35-58 (1981)) are amplified by polymerase chain reaction (PCR) using the following primers: 5′-CAT CAC CAT CAC CAT CAC ACT AAA CCT CCT GAG TAC GGT G-3′ (primer 1), and 5′-5 Phos/CGG TGC GGG CCT CTT CGC TAT TGC TTA/ AGA CTC CTT ATT ACG CAG TAT GTT AG-3′ (primer 2). M13 mp18 (New England Biolabs, Beverly, Mass.) is used as template, and PCR is performed using Expand high-fidelity PCR system (Roche Molecular Biochemicals, Indianapolis, Ind.) as described in Example 5 of U.S. Pat. No. 6,794,132, the contents of which are incorporated by reference herein in their entirety, including all tables, figures, and claims.

The dsDNA product of the PCR process is subjected to asymmetric PCR using only kinased primer 2 to generate substantially only the anti-sense strand of the Gene III fragment, as described in Example 5 of U.S. Pat. No. 6,794,132. The single stranded DNA is purified by high performance liquid chromatography (HPLC, Example 4, U.S. Pat. No. 6,794,132). The HPLC purified ss-DNA is dissolved in water and quantified by absorbance at 260 nm (Example 4, U.S. Pat. No. 6,794,132).

The kinased ss-DNA is used to mutate BS45 uracil template (Example 5, U.S. Pat. No. 6,794,132). Individual phage samples resulting from electroporation of the mutagenesis DNA are checked for insert by PCR, followed by sizing of the PCR products by agarose gel electrophoresis. The sequence of the clones is verified by the dideoxy chain termination method using a Big Dye Terminator v3.1 Sequencing Kit (Applied Biosystems, Foster City, Calif.) and a 3100 Avant Genetic Analyzer (Applied Biosystems, Foster City, Calif.). The resulting phage vector is called BS 100.

### Example 6

### Preparation of N1/C Gene III Phage Vector

The BS100 antibody phage display vector described above is used as the starting vector for inserting domain N1 of M13 gene III between a poly-histidine tag sequence at the C-terminus of the constant region of the antibody heavy chain and the glycine rich linker preceding the N-terminus of gene III domain C. Domain N1 and the first glycine rich linker L1 (amino acids 19-104, Beck and Zink, Gene 16, 35-58 (1981)) are amplified by polymerase chain reaction (PCR) using the following primers: 5′-CAT CAC CAT CAC CAT CAC GCT GAA ACT GTT GAA AGT TGT TTA GC-3′ (primer 3), and 5′-5 Phos/GA GCC ACC ACC GGA ACC GCC /ACC GCC ACC CTC AGA ACC GC-3′ (primer 4). M 13 mp 18 (New England Biolabs, Beverly, Mass.) is used as template, and PCR is performed using Expand high-fidelity PCR system (Roche Molecular Biochemicals, Indianapolis, Ind.) as described in Example 5 of U.S. Pat. No. 6,794,132.

The rest of the procedure is as described above for BS 100. The resulting gene III construct consists of amino acids 19-104 being fused to amino acids 265-424. The resulting phage vector is called BS101.

### Example 7

### Enrichment of polyclonal phage displaying antibody to chorionic gonadotrophin (hCG) using an N1/C Gene III Fusion vector

The first round antibody phage was generally prepared as described in WO 03/068956, the contents of which are incorporated by reference herein in their entirety, including all tables, figures, and claims, from mice immunized with hCG (Scripps Laboratories, San Diego, Calif.) using BS79 uracil template. BS79 is identical to BS 101 except it has an additional histidine at the C-terminus of the heavy chain, the last codon of the pelB signal sequence is missing, and some of the codons of the gene III sequence described for BS101 were changed, without changing the resulting pIII amino acid sequence, to reduce the risk of rearrangement. Ten electroporations of mutagenesis DNA had efficiencies ranging from 1.1×10⁸ PFU to 1.9×10⁸ PFU. The 10 electroporations yielded 10 different phage samples. Two rounds of panning were done with each of the 10 antibody phage samples at 10⁻⁸ M hCG-biotin (see WO 03/068956 for panning details). After the 2^{nd} round of panning, the phage samples were pooled to one sample, and a 3^{rd} round of panning was performed with the pooled phage at 10⁻⁹ M hCG-biotin. The hCG-biotin was generally prepared as described in U.S. Pat. No. 6,057,098 (Example 9). After 3 rounds of panning, the foreground:background ratio was >10,000:150.

One skilled in the art readily appreciates that the present invention is well adapted to carry out the objects and obtain the ends and advantages mentioned, as well as those inherent therein. The examples provided herein are representative of preferred embodiments, are exemplary, and are not intended as limitations on the scope of the invention. Modifications therein and other uses will occur to those skilled in the art. These modifications are encompassed within the spirit of the invention and are defined by the scope of the claims.

It will be readily apparent to a person skilled in the art that varying substitutions and modifications may be made to the invention disclosed herein without departing from the scope and spirit of the invention.

All patents and publications mentioned in the specification are indicative of the levels of those of ordinary skill in the art to which the invention pertains. All patents and publications are herein incorporated by reference to the same extent as if each individual publication was specifically and individually indicated to be incorporated by reference.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

Other embodiments are set forth within the following claims.

1. A method for propagation of replicable genetic packages, comprising:
a. contacting a first population of replicable genetic packages (rgps) comprising one or more members displaying a polypeptide of interest on a surface thereof as a fusion protein with a package surface protein, with one or more proteolytic enzymes under conditions selected to remove all or a portion of the fusion protein from the surface of one or more of said members, thereby improving propagation of population members displaying said polypeptide of interest, to provide a proteolyzed population of rgps; and
b. contacting a host cell population with said proteolyzed population of rgps under conditions selected to propagate one or more members of said proteolyzed population of rgps.

2. A method according to claim 1, wherein said rgps are filamentous phage.

3. A method according to claim 1, wherein said rgps are selected from the group consisting of M13, fd, f1, and engineered variants thereof.

4. A method according to claim 1, wherein said host cells are E. coli cells.

5. A method according to claim 1, wherein said one or more proteolytic enzymes are selected from the group consisting of factor Xa, enterokinase, thrombin, tobacco etch virus protease, and human rhinovirus 3C protease.

6. A method according to claim 5, wherein said fusion protein comprises an introduced cleavage site for one or more of said proteolytic enzymes.

7. A method according to claim 1, wherein said introduced cleavage site is introduced distally to residues encoding said package surface protein.

8. A method according to claim 1, wherein said fusion protein comprises an introduced proteolytic cleavage site selected from the group consisting of IEGR (SEQ ID NO:1), DDDDK (SEQ ID NO:2), LVPRGS (SEQ ID NO:3), ENLYFQG (SEQ ID NO:4), and LEVLFQGP (SEQ ID NO:5).

9. A method according to claim 1, further comprising enriching said propagated population of rgps for members displaying said polypeptide of interest on a surface thereof as said fusion protein.

10. A method for performing phage display, comprising:
a. expressing from host cells a bacteriophage population comprising one or more bacteriophage displaying a polypeptide of interest on a surface thereof as a fusion protein with a bacteriophage coat protein;
b. enriching the proportion of bacteriophage in said bacteriophage population displaying said polypeptide of interest by contacting said bacteriophage population with an affinity target for said polypeptide of interest and removing unbound bacteriophage;
c. contacting said bacteriophage population with one or more proteolytic enzymes under conditions selected to remove all or a portion of the fusion protein from the surface of one or more of said bacteriophage, thereby improving propagation of bacteriophage displaying said polypeptide of interest; and
d. propagating one or more members of said bacteriophage population in host cells.

11. A method according to claim 10, wherein said bacteriophage are filamentous phage.

12. A method according to claim 11, wherein said bacteriophage are selected from the group consisting of M13, fd, f1, and engineered variants thereof.

13. A method according to claim 10, wherein said host cells are E. coli cells.

14. A method according to claim 10, wherein said one or more proteolytic enzymes are selected from the group consisting of factor Xa, enterokinase, thrombin, tobacco etch virus protease, and human rhinovirus 3C protease.

15. A method according to claim 14, wherein said fusion protein comprises an introduced cleavage site for one or more of said proteolytic enzymes.

16. A method according to claim 15, wherein said introduced cleavage site is introduced distally to residues encoding said bacteriophage coat protein.

17. A method according to claim 10, wherein said fusion protein comprises an introduced proteolytic cleavage site selected from the group consisting of IEGR (SEQ ID NO:1), DDDDK (SEQ ID NO:2), LVPRGS (SEQ ID NO:3), ENLYFQG (SEQ ID NO:4), and LEVLFQGP (SEQ ID NO:5).

18. A method according to claim 10, wherein said expressing step (a) comprises contacting said host cells with a phagemid encoding said fusion protein.

19. A method according to claim 10, wherein said fusion protein comprises said polypeptide of interest fused to all or a portion of pIII.

20. A method according to claim 10, further comprising repeating steps b-d one or more times.

21-35. (canceled)

36. A method for the display of one or more polypeptides of interest as fusion proteins on filamentous phage, comprising:
a. expressing from a host cell a bacteriophage expressing a fusion protein comprising a first segment of amino acids heterologous to said filamentous phage;
b. a second segment of amino acids comprising either the N1 or N2 domain but not both of a pIII protein fused to said first segment; and
c. a third segment of amino acids comprising the C domain of the pIII protein, wherein the second sequence is fused directly or via a linker of from 1-60 amino acids to the third segment.


SEQUENCE LISTING (13 sequences)

SEQ ID NO: 1 - protein, 4 aa, Artificial
  Proteolytic cleavage site
IEGR

SEQ ID NO: 2 - protein, 5 aa, Artificial
  Proteolytic cleavage site
DDDDK

SEQ ID NO: 3 - protein, 6 aa, Artificial
  Proteolytic cleavage site
LVPRGS

SEQ ID NO: 4 - protein, 7 aa, Artificial
  Proteolytic cleavage site
ENLYFQG

SEQ ID NO: 5 - protein, 8 aa, Artificial
  Proteolytic cleavage site
LEVLFQGP

SEQ ID NO: 6 - protein, 4 aa, Artificial
  Proteolytic cleavage site
IXGR

SEQ ID NO: 7 - DNA, 72 bp, Artificial
  Mutagenic oligonucleotide No. 1823
cagacaagcactagtagaaccacgcggaaccagagaaccgccaccagtgccaccgccagaatccctgggcac

SEQ ID NO: 8 - protein, 8 aa, Artificial
  Peptide linker
GGGTGGGS

SEQ ID NO: 9 - DNA, 40 bp, Artificial
  Primer 1
catcaccatcaccatcacactaaacctcctgagtacggtg

SEQ ID NO: 10 - DNA, 53 bp, Artificial
  Primer 2
cggtgcgggcctcttcgctattgcttaagactccttattacgcagtatgttag

SEQ ID NO: 11 - DNA, 44 bp, Artificial
  Primer 3
catcaccatcaccatcacgctgaaactgttgaaagttgtttagc

SEQ ID NO: 12 - DNA, 40 bp, Artificial
  Primer 4
gagccaccaccggaaccgccaccgccaccctcagaaccgc

SEQ ID NO: 13 - protein, 424 aa, M13 filamentous phage
MKKLLFAIPLVVPFYSHSAETVESCLAKPHTENSFTNVWKDDKTLDRYANYEGCLWNATGVVVCTGDETQCYGTWVPIGLAIPENEGGGSEGGGSEGGGSEGGGTKPPEYGDTPIPGYTYINPLDGTYPPGTEQNPANPNPSLEESQPLNTFMFQNNRFRNRQGALTVYTGTVTQGTDPVKTYYQYTPVSSKAMYDAYWNGKFRDCAFHSGFNEDPFVCEYQGQSSDLPQPPVNAGGGSGGGSGGGSEGGGSEGGGSEGGGSEGGGSGGGSGSGDFDYEKMANANKGAMTENADENALQSDAKGKLDSVATDYGAAIDGFIGDVSGLANGNGATGDFAGSNSQMAQVGDGDNSPLMNNFRQYLPSLPQSVECRPFVFSAGKPYEFSIDCDKINLFRGVFAFLLYVATFMYVFSTFANILRNKES